(19) United States
(12) Patent Application Publication
(10) Pub. No.: US 2008/0186831 A1
(43) Pub. Date: Aug. 7, 2008

(54) Optical Scanning Device

(75) Inventors: Teunis Willem Tukker, Eindhoven (NL); Coen Theodorus Hubertus Fransiscus Liedenbaum, Eindhoven (NL); Bernardus Hendrikus Wilhelmus Hendriks, Eindhoven (NL); Sjoerd Stallinga, Eindhoven (NL); Albert Hendrik Jan Immink, Eindhoven (NL); Stein Kuiper, Eindhoven (NL); Ming Song Chen, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,806

(22) PCT Filed: Mar. 6, 2006
(86) PCT No.: PCT/IB06/50691

§ 371 Date: Sep. 5, 2007

(30) Foreign Application Priority Data
Mar. 11, 2005 (EP) 05101897.6

(51) Int. Cl. G11B 7/00

(52) U.S. Cl. 369/112.01

(57) ABSTRACT

An optical scanning device (1) includes a radiation source (7), a detector (23) and a beam splitter (9). The radiation source (7) provides an incident radiation beam (4, 20) along a first optical path (19a) for scanning an information layer (2) of an optical record carrier (3). The detector (23) detects at least a portion of the radiation beam (22) reflected from the optical record carrier (3). The beam splitter (9) transmits the incident radiation beam (4) received from the radiation source along the first optical path (19a) towards the optical record carrier. The beam splitter (9) also transmits the reflected beam (22) received from the optical record carrier (3) along a second, different optical path (19b) towards the detector. The optical scanning device further includes a beam-deflecting element (30; 130; 230; 330; 630; 830; 930) positioned on the second optical path (19b) between the beam splitter (9) and the detector (23). The beam-deflecting element (30; 130; 230; 330; 630; 830; 930) is arranged to controllably deflect the path of the reflected radiation beam (22) for adjusting the lateral position of said reflected radiation beam incident upon the detector (23) over a predetermined range.

The present invention relates to optical scanning devices, and methods of operation and manufacture of such devices. Embodiments of the invention are particularly suitable for compensating for misalignment of the laser and the detector with respect to each other.

In optical scanning device used to read optical discs, it is important that the light used to scan the disc is focused correctly on the information layer of the disc. Consequently, optical scanning devices normally utilize a focus error detector, with the signal being used to control the focusing of the light on the information layer.

Most conventional focus error detection methods used in optical scanning devices utilize the fact that the shape or the light intensity distribution of the light reflected from the disc varies according to the focus error of the light. Typically, the light reflected from the disc (or at least a portion thereof) is received by a multi-division photo detector, with an imbalance in the output signals (indicative of the received intensity) from each portion of the detector being used as the focus error detection signal.

For example, an astigmatic method of focus error detection is described in JP-B-54-41883. The light reflected from the disc is given astigmatism by being passed through an astigmatic element such as a cylindrical lens. The reflected light is then focused in two focal lines perpendicular to each other, with the resulting beam profile being circular at a position of minimum confusion (typically referred to as the “least confusion circle”) roughly midway between the two focal lines.

A quadrant photo detector is placed at the position of the least confusion circle, to receive the light reflected from the disc. The shape of the spot formed on the detection surface of the four-division photo detector by the reflected light is thus substantially circular when the light is correctly focused on the disc being scanned.

If the light incident upon the disc is not correctly focused, the shape of the spot formed by the reflected light changes shape (e.g. it can become an ellipse), with the shape (e.g. orientation of the ellipse) being dependent upon whether the light used to scan the disc is focused above or below the disc. Thus, by measuring the light intensity incident upon each of the four detector elements of the quadrant photo detector, a focus error detection signal can be realized to control the focusing of the light on the disc. For instance, first and second output signals can be realized by summing the output from the diagonally opposite detector elements of the photo detector. The difference between the two output signals is then taken as the focus error detection signal.

The above technique assumes that the reflected beam forms a circular spot (when the scanned disc is in focus) that is located centrally on the quadrant detector i.e. one quarter of the circular spot is incident upon each of the four elements of the detector. The beam-landing error is the deviation of the spot from being focused centrally on the detector. The beam-landing error has direct influence on the focus error and tracking error signals, with the result that if the beam-landing error is too large, the optical scanning device can deliver poor performance, or even fail completely. If the beam-landing error is too large, then the servo controller used to alter the focusing of the scanning light on the disc can be unable to correctly control the focus of light on, or tracking of light along, the disc.

Typically, during manufacture, the positions of the optical components within the optical scanning device are optimized, to minimize beam-landing error. However, the positions of the optical components can be displaced due to temperature changes and/or gradual movement of the components (creep of the components) during the lifetime of the device, leading to bad device performance and eventually complete failure in the operation of the device.

It is an aim of embodiments of the present invention to address one or more problems of the prior art, whether referred to herein or otherwise.

According to a first aspect of the present invention there is provided an optical scanning device comprising, a radiation source for providing an incident radiation beam along a first optical path for scanning an information layer of an optical record carrier, a detector for detecting at least a portion of the radiation beam reflected from the optical record carrier, and a beam splitter for transmitting the incident radiation beam received from the radiation source along the first optical path towards the optical record carrier, and for transmitting said reflected beam received from the optical record carrier along a second, different optical path towards the detector, wherein the optical scanning device further comprises a beam deflecting element positioned on the second optical path between the beam splitter and the detector, and arranged to controllably deflect the path of the reflected radiation beam for adjusting the lateral position of said reflected radiation beam incident upon the detector over a predetermined range.

By utilizing such a beam-deflecting element, the device can ensure that the reflected beam of radiation is positioned correctly on the detector to minimize beam-landing error. This component thus allows the device to compensate for variations in the positions of the optical components (due to ageing or temperature) that would otherwise result in the reflected beam being incorrectly laterally positioned on the detector. Such a function is particularly useful in optical scanning devices that utilize only a single spot on the detector for determining focus error, but can equally be utilized in devices using three or more spots focused on different portions of the detector, for error correction. If the device is used with three or more spots, then one device may be used to deflect all of the beams used to provide the spots, or alternatively a different beam deflecting element may be utilized for each beam.

The beam-deflecting element may be arranged to alter the path of said reflected radiation beam by refraction.

The beam-deflecting element may comprise a material of variable refractive index, at least one surface of the material extending across, but not perpendicular to, the second optical path.

The material of variable refractive index may comprise a nematic liquid crystal.

The beam deflecting element may comprise a chamber containing a first fluid having a first refractive index, a second fluid having a second, different refractive index separated from the first fluid across an interface, the interface extending across the second optical path, and an interface controller arranged to alter the configuration of the interface.

Said interface controller may be arranged to alter the shape of the interface.

Preferably, said interface controller is arranged to alter the angle of the interface relative to the optical path.

Preferably, one of said fluids is electrically susceptible (e.g. conductive or polar), and the interface controller is arranged to alter the configuration of the interface utilizing the electrowetting effect.

Preferably, said interface is substantially planar.

Said interface may be curved for focusing said reflected beam on the detector.

The optical scanning device may further comprise a beam deflection controller arranged to alter the deflection provided by the beam deflecting element in dependence upon the signal detected by said detector.

A focus error signal may be formed by the astigmatic method, with the radiation beam reflected from the optical carrier forming only a single spot on the detector.

The detector may comprise at least two detector elements.

Preferably, the detector is a quadrant detector, said beam deflecting element is arranged to controllably deflect the path of the reflected radiation beam for adjusting the lateral position in a first direction of said reflected radiation beam incident upon the detector; and wherein the device further comprises a further beam deflecting element positioned on the second optical path between the beam splitter and the detector, and arranged to controllably deflect the path of the reflected radiation beam for adjusting the lateral position of said reflected radiation beam incident upon the detector in a second direction substantially perpendicular to the first direction.

According to a second aspect of the present invention there is provided a method of operating an optical scanning device, the device comprising: a radiation source for providing an incident radiation beam along a first optical path for scanning an information layer of an optical record carrier; a detector for detecting at least a portion of the radiation beam reflected from the optical record carrier; a beam splitter for transmitting the incident radiation beam received from the radiation source along the first optical path towards the optical record carrier, and for transmitting said reflected beam received from the optical record carrier along a second, different optical path towards the detector; and a beam deflecting element positioned on the second optical path between the beam splitter and the detector, and arranged to controllably deflect the path of the reflected radiation beam for adjusting the lateral position of said reflected radiation beam incident upon the detector over a predetermined range, the method comprising controlling the deflection provided by said beam to the path of the reflected radiation beam, for providing the reflected radiation beam incident upon the detector at a predetermined lateral position.

According to a third aspect of the present invention there is provided a method of manufacturing an optical scanning device, may comprise providing a radiation source for providing an incident radiation beam along a first optical path for scanning an information layer of an optical record carrier, providing a detector for detecting at least a portion of the radiation beam reflected from the optical record carrier; and providing a beam splitter for transmitting the incident radiation beam received from the radiation source along the first optical path towards the optical record carrier, and for transmitting said reflected beam received from the optical record carrier along a second, different optical path towards the detector; and providing a beam deflecting element positioned on the second optical path between the beam splitter and the detector, arranged to controllably deflect the path of the reflected radiation beam for adjusting the lateral position of said reflected radiation beam incident upon the detector over a predetermined range.

Embodiments of the present invention will now be described, by way of example only, with reference to the accompanying figures, in which:

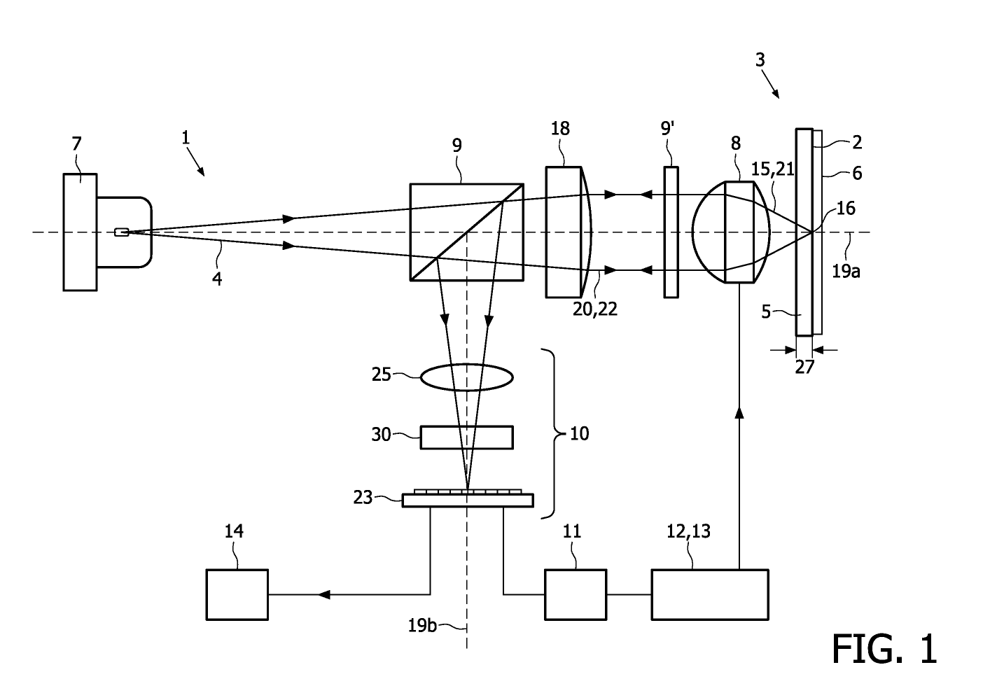

FIG. 1 is a schematic diagram of an optical scanning device in accordance with an embodiment of the present invention;

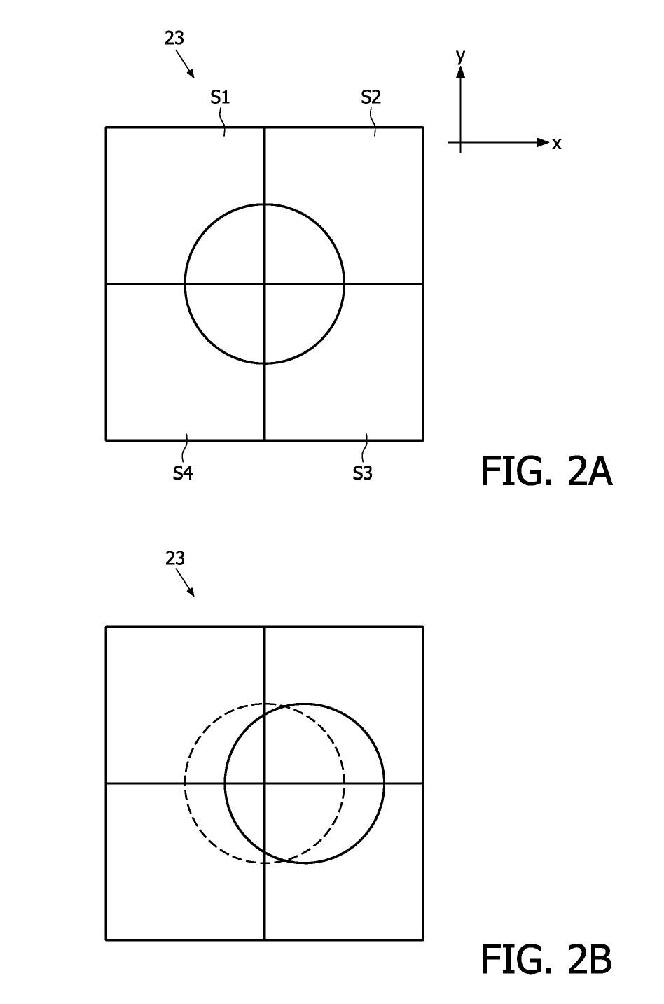

FIGS. 2A and 2B illustrate plan views of a quadrant detector with the reflected beam respectively centrally positioned and laterally displaced in the X direction;

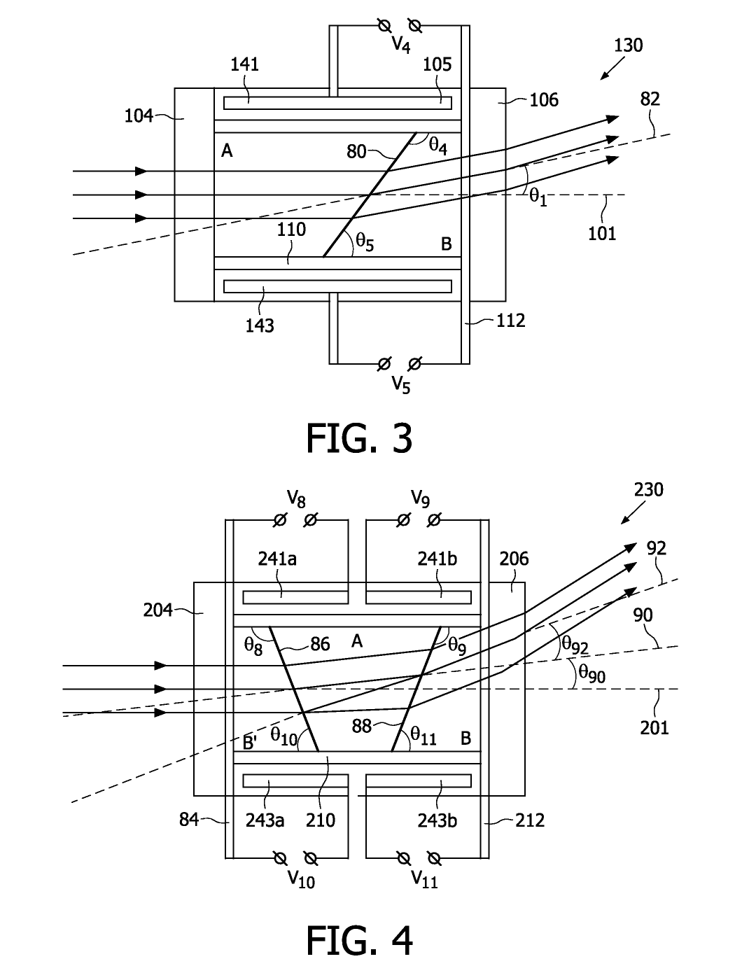

FIGS. 3, 4 and 5 each show a simplified side view cross-section of a beam-deflecting element incorporating a meniscus apparatus for refractive beam deflection in accordance with embodiments of the present invention;

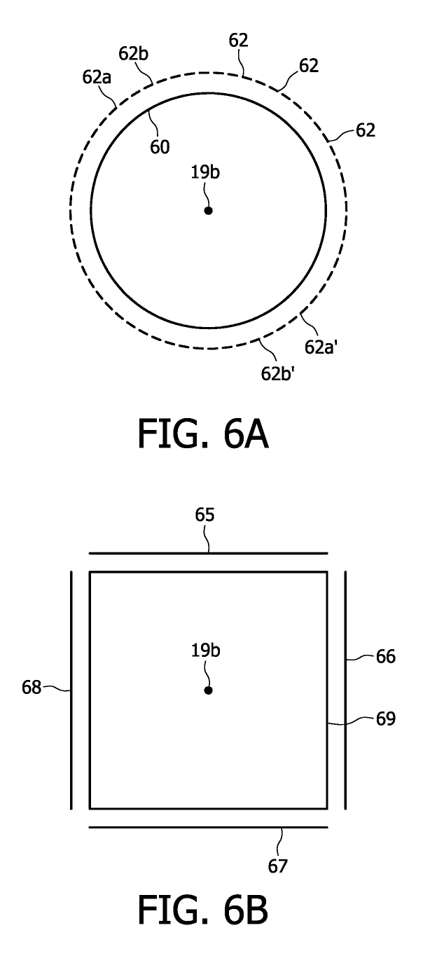

FIGS. 6A and 6B show top view cross-sections of alternative electrode configurations for use in any of the beam deflecting elements shown in FIGS. 3 to 5;

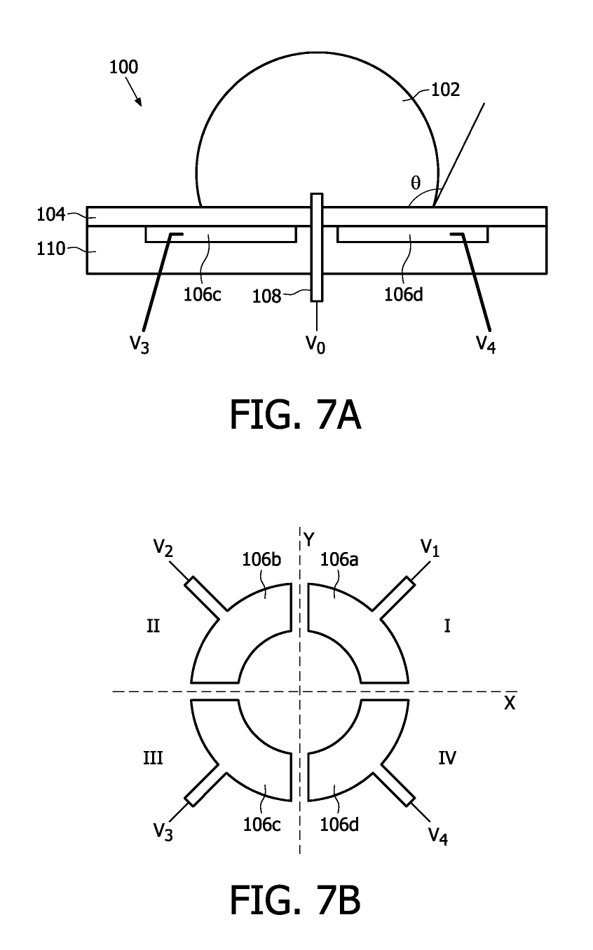

FIG. 7A shows a side cross-sectional view of a beam-deflecting element additionally suitable for focusing the beam, in accordance with a further embodiment of the present invention;

FIG. 7B shows a plan view of the electrode arrangement of the element shown in FIG. 7A;

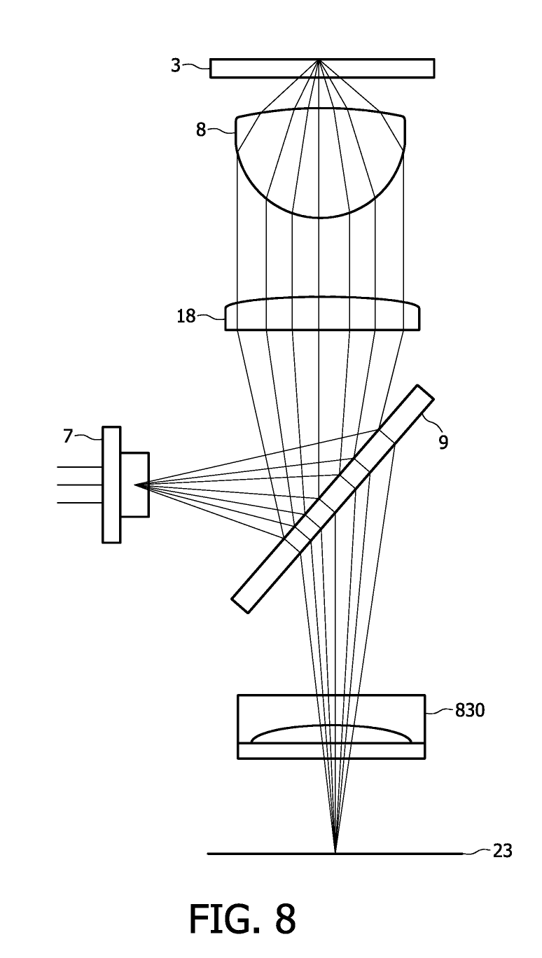

FIG. 8 shows a simplified schematic diagram of an optical scanning device in accordance with the further embodiment of the present invention; and

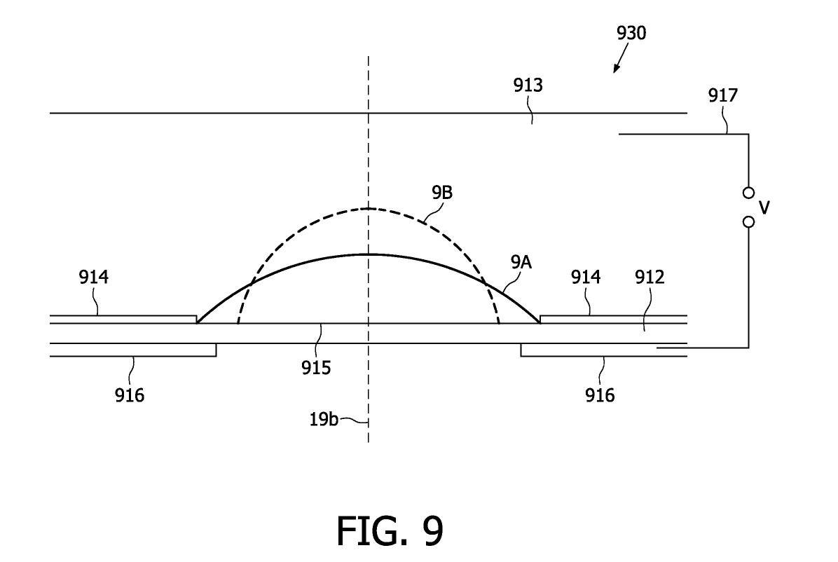

FIG. 9 shows a simplified cross-sectional side view of a beam-deflecting element suitable for use in the optical scanning device of FIG. 8.

The present inventors have realized that the problems of creep and temperature dependence of beam-landing error may be alleviated by incorporating a beam-deflecting element within the optical scanning device. The beam-deflecting element acts to alter the path of radiation incident upon the element, in a controllably variable manner. The beam-deflecting element is arranged to controllably deflect the path of the radiation beam over a predetermined range. The beam-deflecting element is positioned within the scanning device so as to control the position of the spot formed by the reflected radiation beam upon the surface of the detector. In particular, the beam deflector element is arranged to alter the lateral position of the spot formed by the reflected beam on the detector over a predetermined range, so as to ensure the spot is in a predetermined, preferred position (e.g. central to the detector).

An optical scanning device including the beam-deflecting element will now be described in more detail, and then subsequently further details of beam deflecting elements of preferred embodiments then described.

FIG. 1 shows a device 1 for scanning a first information layer 2 of a first optical record carrier 3 by means of a first radiation beam 4, the device including an objective lens system 8.

The optical record carrier 3 comprises a transparent layer 5, on one side of which information layer 2 is arranged. The side of the information layer 2 facing away from the transparent layer 5 is protected from environmental influences by a protective layer 6. The side of the transparent layer facing the device is called the entrance face. The transparent layer 5 acts as a substrate for the optical record carrier 3 by providing mechanical support for the information layer 2. Alternatively, the transparent layer 5 may have the sole function of protecting the information layer, while the mechanical support is provided by a layer on the other side of the information layer 2, for instance by the protective layer 6 or by an additional information layer and transparent layer connected to the uppermost information layer. It is noted that the information layer has first information layer depth 27 that corresponds, in this embodiment as shown in FIG. 1, to the thickness of the transparent layer 5. The information layer 2 is a surface of the carrier 3.

Information is stored on the information layer 2 of the record carrier in the form of optically detectable marks arranged in substantially parallel, concentric or spiral tracks, not indicated in the figure. A track is a path that may be followed by the spot of a focused radiation beam. The marks may be in any optically readable form, e.g. in the form of pits, or areas with a reflection coefficient, or a direction of magnetization different from the surroundings, or a combination of these forms. In the case where the optical record carrier 3 has the shape of a disc.

As shown in FIG. 1, the optical scanning device 1 includes a radiation source 7, a collimator lens 18, a beam splitter 9, an objective lens system 8 having an optical axis 19a, and a detection system 10. Furthermore, the optical scanning device 1 includes a servo circuit 11, a focus actuator 12, a radial actuator 13, and an information-processing unit 14 for error correction.

In this particular embodiment, the radiation source 7 is arranged for consecutively or simultaneously supplying a first radiation beam 4, a second radiation beam 4′ and a third radiation beam 4″. For example, the radiation source 7 may comprise a tunable semiconductor laser for consecutively supplying the radiation beams 4, 4′ and 4″, or three semiconductor lasers for simultaneously supplying these radiation beams.

The radiation beam 4 has a wavelength λᵢ and a polarization p₁, the radiation beam 4′ has a wavelength λ₂ and a polarization p₂, and the radiation beam 4″ has a wavelength λ₃ and a polarization p₃. The wavelengths λ₁, λ₂, and λ₃ are all different. Preferably, the difference between any two wavelengths is equal to, or higher than, 20 nm, and more preferably 50 nm. Two or more of the polarizations p₁, p₂, and p₃ may differ from each other.

The collimator lens 18 is arranged on the optical axis 19a for transforming the radiation beam 4 into a substantially collimated beam 20. Similarly, it transforms the radiation beams 4′ and 4″ into two respective substantially collimated beams 20′ and 20″ (not shown in FIG. 1).

The beam splitter 9 is arranged for transmitting the radiation beams towards the objective lens system 8. Preferably, the beam splitter 9 is formed with a plane parallel plate that is tilted at an angle α with respect to the optical axis, and more preferably α=45′. In this particular embodiment the optical axis 19a of the objective lens system 8 is common with the optical axis of the radiation source 7.

The objective lens system 8 is arranged for transforming the collimated radiation beam 20 to a first focused radiation beam 15 so as to form a first scanning spot 16 in the position of the information layer 2.

During scanning, the record carrier 3 rotates on a spindle (not shown in FIG. 1), and the information layer 2 is then scanned through the transparent layer 5. The focused radiation beam 15 reflects on the information layer 2, thereby forming a reflected beam 21, which returns on the optical path of the forward converging beam 15. The objective lens system 8 transforms the reflected radiation beam 21 to a reflected collimated radiation beam 22. The beam splitter 9 separates the forward radiation beam 20 from the reflected radiation beam 22 by transmitting at least part of the reflected radiation 22 towards to detection system 10. In the particular embodiment shown, the beam splitter 9 is a polarizing beams splitter. A quarter waveplate 9′ is positioned along the optical axis 19 between the beam splitter 9 and the objective lens system 8. The combination of the quarter waveplate 9′ and the polarizing beam splitter 9 ensures that the majority of the reflected radiation beam 22 is transmitted towards the detection system 10 along detection system optical axis 19b.

The detection system 10 includes a convergent lens 25 and a quadrant detector 23, which are arranged for capturing said part of the reflected radiation beam 22. The optical axis 19b passes through the center of detector 23. The detection system further includes at least one beam-deflecting element 30. The beam-deflecting element is positioned between the beam divider 9 and the detector 23. The deflection provided by the beam deflector element (to the reflected beam 22) is variable. The angle of the reflected beam, relative to the optical axis 19b, is varied by the beam deflector element, so as to alter the lateral position of the spot formed on the detector 23. In this embodiment, the detector 23 is a quadrant detector i.e. it is divided up into four detector elements. Each detector element is arranged to detect the intensity of light incident upon the element. The deflection is typically varied so as to ensure the reflected beam is positioned centrally on the quadrant detector 23.

FIGS. 2A and 2B show plan views of the detector element 23. The detector element 23 is divided into four discrete segments or elements, each providing a respective output S1, S2, S3, S4. The surface of the detector 23 is typically planar. In this embodiment the surface extends within the XY plane. The solid circular line illustrates the position of the circular spot formed by the reflected beam, when the scanning beam is correctly focused on the optical record carrier.

In FIG. 2A, the spot is correctly centrally located on the detector 23, with one quarter of the spot aligned within each quadrant of the detector. In FIG. 2B it will be seen that the spot has been laterally displaced in the X direction, with the preferred position of the spot being indicated by the circular dotted line.

If the spot formed by the reflected beam 22 is displaced from the desired position (as shown in FIG. 2B), then the reflected beam is deflected by the beam deflector element so as to ensure that the spot of the collective beam is positioned centrally on the quadrant detector 23. The deflection provided by the beam deflector element is thus controlled, to ensure the reflected beam spot is correctly located on the detector. The undesirable lateral displacement of the spot from the desired central position may be caused by a number of factors, including environmental conditions such as climatic (temperature and humidity) and transportation (shock/vibration/bumps), as well as deformation, shift or tilting of the components within the optical scanning device due to the device being warped.

The landing error (BL) can be defined as:

$$BL = \sqrt{{P}_{1}^{2} + {P}_{2}^{2}}$$

Where P₁ and P₂ are components of the beam-landing error in two orthogonal directions. For instance, P₁ and P₂ can be defined as:

$${P}_{1} = \frac{( S 1 + S 2 ) - ( S 3 + S 4 )}{S 1 + S 2 + S 3 + S 4} {P}_{2} = \frac{( S 1 + S 4 ) - ( S 2 + S 3 )}{S 1 + S 2 + S 3 + S 4}$$

Where S1, S2, S3 and S4 are respective signals indicative of the intensity of the light incident upon each detector element of the detector 23, assuming that the spot formed by the reflected beam is circular i.e. that the optical record carrier beam scanned is correctly in focus. By comparison of FIGS. 2A and 2B and the above equations, it will be realized that the beam-landing error is zero when the spot is in the position shown in FIG. 2A i.e. located centrally to the detector.

The amount of deflection provided by the beam-deflecting element can be controlled by utilizing jitter. In other words, the amount of deflection provided by the beam deflector alignment is altered by small amounts above and below the current level of deflection, and the effect this has on the beam-landing error is utilized to determine how the deflection needs to be altered to reduce the beam-landing error. Such a control mechanism is particularly suitable for use with a four-quadrant detector.

Alternatively, the amount of deflection provided by the beam-deflecting element can be controlled by using beam-landing error as feedback. One known method of determining a beam landing error signal is to employ the 3-spots-push-pull method. This method utilizes three detector elements: a four-quadrant detector element, along with two additional two-segment detector elements. A central spot is formed on the four-quadrant detector element, and a satellite spot on each of the two-segment detector elements. Once the beam scanning the disc has been correctly focused, the beam landing error is used to control the deflection provided by the beam deflecting element. Even if the scanning beam is not perfectly focused on the optical record carrier (i.e. the beam spot on the detector is slightly elliptical), this has a relatively small affect on the beam landing error. Beam landing area is the imbalance between adjacent lateral quadrant of a four quadrant detector, whereas the focus error signal is derived from the difference between diagonal elements of the four quadrant detector.

If only one spot (a single beam focused on a four-quadrant detector) is utilized for error detection, and a differential phase detection method is used to generate a tracking error signal, then the beam landing error signal can again be utilized to control the beam deflecting element.

The detector is arranged to convert said part of the reflected beam to one or more electrical signals.

One of the signals is an information signal, the value of which represents the information scanned on the information layer 2. The information signal is processed by the information-processing unit 14 for error correction.

Other signals from the detection system 10 are a focus error signal and a radial tracking error signal. The focus error signal represents the axial difference in height along the Z-axis between the scanning spot 16 and the position of the information layer 2. Preferably, this signal is formed by the “astigmatic method” which is known from, inter alias, the book by G. Bouwhuis, J. Braat, A. Huijiser et al, “Principles of Optical Disc Systems”, pp. 75-80 (Adam Hilger 1985, ISBN 0-85274-785-3). The radial tracking error signal represents the distance in the XY-plane of the information layer 2 between the scanning spot 16 and the center of track in the information layer 2 to be followed by the scanning spot 16. This signal can be formed from the “radial push-pull method” which is also known from the aforesaid book by G. Bouwhuis, pp. 70-73.

The servo circuit 11 is arranged for, in response to the focus and radial tracking error signals, providing servo control signals for controlling the focus actuator 12 and the radial actuator 13 respectively. The focus actuator 12 controls the position of the objective lens 8 along the Z-axis, thereby controlling the position of the scanning spot 16 such that it coincides substantially with the plane of the information layer 2. The radial actuator 13 controls the radial position of the scanning spot 16 so that it coincides substantially with the centerline of the track to be followed in the information layer 2 by altering the position of the objective lens 8.

The objective lens 8 is arranged for transforming the collimated radiation beam 20 to the focus radiation beam 15, having a first numerical aperture NA₁, so as to form the scanning spot 16. In other words, the optical scanning device 1 is capable of scanning the first information layer 2 by means of the radiation beam 15 having the wavelength λ₁, the polarization p₁ and the numerical aperture NA₁.

Furthermore, although not shown, the optical scanning device in this embodiment is also capable of scanning a second information layer 2′ of a second optical record carrier 3′ by means of the radiation beam 4′, and a third information layer 2″ of a third optical record carrier 3″ by means of the radiation beam 4″. Thus, the objective lens system 8 transforms the collimated radiation beam 20′ to a second focused radiation beam 15′, having a second numerical aperture NA₂ so as to form a second scanning spot 16′ in the position of the information layer 2′. The objective lens 8 also transforms the collimated radiation beam 20″ to a third focused radiation beam 15″, having a third numerical aperture NA₃ so as to form a third scanning spot 16″ in the position of the information layer 2″.

Any one or more of the scanning spots 16, 16′, 16″ may be formed with two additional spots for use in providing an error signal. These associated additional spots can be formed by providing an appropriate diffractive element in the path of the optical beam 20.

Similarly to the optical record carrier 3, the optical record carrier 3′ includes a second transparent layer 5′ on one side of which the information layer 2′ is arranged with the second information layer depth 27′, and the optical record carrier 3″ includes a third transparent layer 5″ on one side of which the information layer 2″ is arranged with the third information layer depth 27″.

In this embodiment, the optical record carrier 3, 3′ and 3″ are, by way of example only, a “Blu-ray Disc”-format disc, a “Red-DVD”-format disc and a CD-format disc, respectively. Thus, the wavelength λ₁ is comprised in the range between 365 and 445 nm, and preferably, is 405 nm. The numerical aperture NA₁ equals about 0.85 in both the reading mode and the writing mode. The wavelength λ₂ is comprised in the range between 620 and 700 nm, and preferably, is 650 nm. The numerical aperture NA₂ equals about 0.6 in the reading mode and is above 0.6, preferably 0.65, in the writing mode. The wavelength λ₃ is comprised in the range between 740 and 820 nm and, preferably is about 785 nm. The numerical aperture NA₃ is below 0.5, preferably 0.45.

The beam deflector element can be implemented in a variety of ways.

Preferably, the beam deflector element is arranged to provide a predetermined continuous range of deflection of the incident deflected beam. This allows the position of the radiation beam incident upon the detector to be adjusted over a continuous predetermined range.

In certain embodiments, a beam deflector will only be arranged to controllably deflect the beam in one dimension. For instance, an element might only be arranged to deflect the optical beam to alter the lateral position of the spot on the surface in the X direction, in the sense shown in FIGS. 2A and 2B. In such an instance, preferably the optical scanning device includes a second beam deflector element, orientated to provide beam deflection in an orthogonal direction to that provided by the first beam deflector element. The beam deflector elements will normally be placed sequentially along the optical axis 19b of the detector system. For instance, if a first beam deflector element is arranged to alter the lateral position of the spot in the X direction, then the second beam deflector element is preferably arranged to alter the lateral position of the spot in the Y direction (assuming the detector lies in the XY plane, as shown in FIGS. 2A and 2B).

Suitable beam deflector elements are, for instance described within International Application No. PCT/IB2003/005325, published as WO 2004/051323, “Apparatus for forming variable fluid meniscus configurations”. Such an apparatus comprises a fluid chamber holding two different fluids (A, B) separated by an interface (a meniscus). The edge of the meniscus is constrained by the sidewalls of the fluid chamber. The two fluids are immiscible, and have different refractive indices. One of the fluids is a non-conducting non-polar fluid (e.g. silicone oil or an alkane), and the other is an electrically susceptible fluid (i.e. it reacts to an electric field) e.g. an electrically conducting polar fluid, such as an aqueous salt solution. Either or both of the fluids may be liquid, or gas, or any material subject to flow e.g. a liquid crystal. Preferably, the two fluids have a substantially equal density, so that the apparatus forming the beam deflecting element functions independently of orientation, i.e. without dependence on gravitational effects between the two fluids. This may be achieved by appropriate selection of the first and second fluid constituents.

Electrodes positioned adjacent the walls of the chamber are used to control the contact angle of the edge of the meniscus with the chamber sidewall. The electrodes are coated with an electrically insulating layer e.g. of parylene. The chamber is typically cylindrical, extending along the optical axis of the optical element. Various embodiments of different beam deflecting elements are illustrated in FIGS. 3, 4 and 5. In each instance, the cross-section of the cylindrical chamber may be of any desired shape, including circular (as indicated in FIG. 6A) or square (as indicated in FIG. 6B).

FIGS. 6A and 6B illustrate two alternative cross-sections of the chamber, taken perpendicular to the optical axis 19b. In FIG. 6A, the chamber has a circular internal sidewall 60. A plurality of segment electrodes are located about the optical axis 19b of the beam-deflecting element. The sidewall segment electrodes 62 are grouped in pairs, illustrated by example with labels 62a and 62a′, and 62b and 62b′ etc. Each member of a pair lies parallel to the other on the opposite side of the optical axis 19b. A voltage control circuit (not shown) is connected to the electrode configuration to apply varying voltage patterns to the segment electrodes 2.

FIG. 6B shows an alternative cross-section of a chamber having side walls 69 defining a square. Two axially-spaced sets of electrowetting sidewall electrodes 65, 67 and 66, 68 are spaced about the perimeter of the chamber. The four rectangular segment electrodes 65, 66, 67, 68 are spaced about the optical axis 19b of the beam deflecting element. Opposite segment electrodes 65, 67 are arranged as a pair, and electrodes 66, 68 are arranged as a pair. The longitudinal edges of each pair of electrodes is parallel.

Typically, a further, end electrode will be in electrical contact with the conducting fluid contained within the chamber. Voltages are applied across the end electrode and each of the individual sidewall electrodes. The voltage applied across the end electrode and any sidewall electrode will act to define the surface contact angle of the adjacent sidewall i.e. the angle at which the meniscus contacts the adjacent portion of the sidewall. Preferably, the voltages applied to pairs of electrodes are arranged such that the contact angle provided on pairs of electrodes is equal to 180°. For example, if a voltage applied between the end electrode and electrode 62a is selected to provide a contact angle at the adjacent side wall position of 60°, then the voltage applied between the end electrode and side wall electrode 62a′ such as to provide a contact angle of 120° adjacent that electrode. The voltages applied to each electrode are preferably selected so as to provide a generally flat (i.e. planar) meniscus, by control of the contact angles of the meniscus.

FIG. 3 shows a side view cross-section of a fluid meniscus configuration suitable for refractive light deflection i.e. for use as a beam deflector element in accordance with the embodiment of the present invention. Sidewall segment electrodes 141, 143 extend longitudinally along the chamber, parallel to the internal sidewall surface of the chamber containing fluids A, B. Meniscus 80 defines the interface between the two fluids A, B. An insulative layer 110 separates the two fluids from contact with the electrodes.

In this particular embodiment, the second fluid B is the conducting polar fluid. An electrode 112 is in electrical contact with the second fluid B. In the particular embodiment shown, the electrode 112 extends continuously over one end of the chamber. In such an instance, the electrode will be transparent e.g. formed from ITO (Indium Tin Oxide). The chamber also has transparent end walls 104, 106.

A voltage V₄ is applied across the end wall electrode 112 and the side wall electrode 141, resulting in the fluid contact angle θ₄ (e.g. 60°) between the liquid A and the fluid contact layer 110. The fluid contact angle is the angle made by the edge of the meniscus 80 with the adjacent sidewall. Similarly, a voltage V₅ is applied across the end wall electrode 112 and the side wall electrode 143, resulting in a fluid contact angle θ₅. In this particular embodiment, voltages V₄ and V₅ are selected such that the sum of the contact angles θ₄ and θ₅ equals 180°. This results in a flat fluid meniscus 80 between the liquids A and B, at least in the dimension illustrated within the Figure.

An incoming light beam with a first optical axis 101 is deflected in the relevant dimension, in a direction perpendicular to the side wall electrodes 141 and 143, by the flat fluid meniscus 80, to produce an exiting light beam with a second optical axis 82, at an angle θ₁ relative to the first optical axis 101. The incoming light is represented by arrows within the FIG. 3. It will be seen that the total deflection of the beam-deflecting element 130 is, in this instance, greater than θ₁ due to the slight refraction of the light beam as it exits end surface 106.

The deflection angle θ₁ can be varied by variation of the applied electrode voltages V₄, V₅. Preferably, the sum of the contact angles θ₄ and θ₅ is maintained at 180°, so as to provide a flat meniscus in the dimension shown.

By swapping the applied voltages V₄ and V₅ with each other, a negative deflection angle of θ₁ is obtained between the second optical axis 82 from the first optical axis 101 in the same angular plane. Thus, by varying the magnitudes of voltages V₄ and V₅, the deflection of the light beam incident to the beam-deflecting element 130 can be controllably varied over a continuous range of deflection angles.

Preferably, the cross-section of the beam deflecting element 130 illustrated in FIG. 3 is similar to that illustrated in FIG. 6B. For instance, electrodes 141, 143 could correspond to electrodes 65, 67 respectively. Another pair of electrodes (not shown, but numbered 142 and 144 for convenience) would then correspond to electrodes 66, 68 respectively. This second electrode pair 142, 144, when viewed cross-sectionally, is positioned perpendicular to the first electrode pair 141, 143. In a similar manner to voltages V₄ and V₅ being applied to electrodes 141 and 143 to provide contact angles θ₄ and θ₅, voltages V₆ and V₇ would be applied respectively to electrodes 142 and 144 to define respective clear contact angles θ₆ and θ₇. Preferably, θ₆ and θ₇ sum to 180°. If voltages V₆ and V₇ are selected such that the fluid contact angles θ₆ and θ₇ are each 90°, then this will result in a flat fluid meniscus 80 between the liquids A and B. In other words, by ensuring that fluid contact angles θ₆ and θ₇ are each 90°, and that the sum of fluid contact angles θ₄ and θ₅ is 180°, then a one dimensional deflection of the light beam incident upon the beam deflecting element 130 will be achieved.

A further one dimensional deflection of an incoming light beam in a plane perpendicular to that of the deflection angle θ₁ is achieved by controlling the applied voltages V₆ and V₇ across the end wall electrode 112 and side wall electrodes 142 or 144 respectively, such that the sum of the corresponding fluid contact angles θ₆ and θ₇ also equals 180°. By variation of the applied electro voltages V₆, V₇, whilst maintaining the sum of θ₆ and θ₇ equal to 180°, an incoming beam of light with first optical axis 101 can be deflected by a second deflection angle θ₂ (not shown), lying in a plane perpendicular to the deflection angle θ₁. Thus, two-dimensional control of the deflection of a light beam can be achieved, allowing control of the spot position on the detector 23 in both X and Y directions.

FIG. 4 shows a side view cross-section of a beam-deflecting element 230 incorporating a fluid meniscus configuration suitable for refractive light deflection in accordance with a further embodiment of the present invention. In the configuration illustrated, a greater angle of total deflection can be achieved than that of the embodiment shown in FIG. 3 (assuming the same fluids are utilized). Features of this embodiment are similar to those described in relation to FIG. 3, but incremented by 100 (e.g. end wall 204 corresponds to end wall 104 in FIG. 3). In this embodiment a second end wall electrode 84 is provided, which is annular in shape and adjacent the front wall 204 (as compared to the first end wall electrode 212, which is annular in shape, and adjacent the back wall 206). This second end wall electrode is arranged with at least one part in the fluid chamber such that the electrodes acts upon a second fluid layer of fluid B, labeled B′ in FIG. 4. The second layer of fluid B (fluid B′) is separated from the layer of liquid A by a first fluid meniscus 86. A second fluid meniscus 88 separates fluid layers A and B. In this particular embodiment, the fluid B′ comprises the same fluid as fluid B as described in the previous embodiment. However, it should be noted that fluid B′ may be any alternative fluid which is non-miscible with fluid A, electrically conducting, and preferably of a substantially equal density to fluids A and B.

In this embodiment, two axially-spaced sets of electrowetting electrodes are spaced at the perimeter of the sidewall. Preferably the electrodes are arranged similar to electrodes 65, 67 in FIG. 6B. One set of electrodes includes electrodes 241a, 243a. The other set includes electrodes 241b, 243b. Variation of the applied voltages V₈ and V₁₀ applied across the second end wall electrode 84 and sidewall electrodes 241 and 243 respectively, cause the corresponding fluid contact angles θ₈ and θ₁₀ to vary. The first fluid meniscus 86 is flat when the sum of the fluid contact angles θ₈ and θ₁₀ equals 180°. Similarly, the shape of the second fluid meniscus 88 can be varied by variation of the applied voltages V₉ and V₁₁ across the first end wall electrode 206 and sidewall electrodes 241 and 243 respectively. The second meniscus 88 is flat when the sum of the fluid contact angles θ₉ and θ₁₁ equals 180° with the applied voltages V₉ and V₁₁.

An incoming light beam along the first optical axis 201 is deflected one dimensionally in the plane of sidewall electrodes 241, 243 by the flat first fluid meniscus 86. The deflected light beam has a second optical axis 90, and is angularly related to the first optical axis 201 by a deflection axis θ₉₀. The deflected light beam with the second optical axis 90 is further deflected by the flat second fluid meniscus 88. The resultant further deflected light beam has a third optical axis 92, which is angularly related to the second optical axis 90 by the deflection angle θ₉₂. The sum of deflection angles θ₉₀ and θ₉₂ gives the combined deflection angle of the incoming light beam due to the interfaces between the fluids. As detailed in relation to previous embodiments, by further applying voltages across each end wall electrodes 204, 206 and each side wall electrode 242, 244 (not shown) respectively, lying perpendicular to side wall electrodes 241, 243, the flat menisci 86 and 88 can be controlled to deflect an incoming light beam in a further angular plane perpendicular to that of deflection angles θ₉₀, θ₉₂, and hence deflect an incoming light beam in two dimensions. By swapping applied voltages across the sidewall electrode pairs with each other, negative values of the deflection angles θ₉₀, θ₉₂ can be achieved. If desired, as in other embodiments, the electrowetting electrodes of this embodiment may be rotated about the optical axis 201 either electrically, or by using a provided rotation mechanism (e.g. mechanical actuator) to achieve correct angular positioning of the fluid menisci.

In a further envisaged embodiment, the two flat fluid menisci 86, 88 are arranged to lie parallel to each other, using only a single set of electrodes spaced about the perimeter of the chamber.

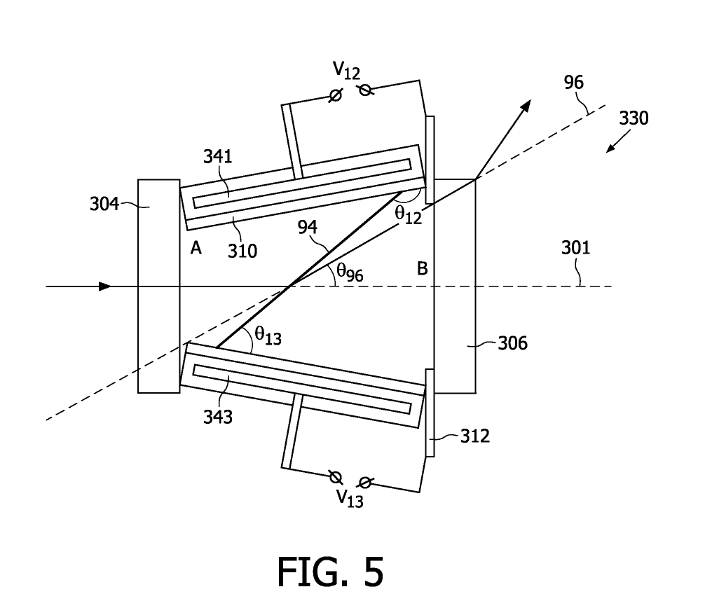

FIG. 5 shows a side cross-section view of a further embodiment of a beam deflector element 330 using a fluid meniscus configuration suitable for refractive light deflection. In the embodiments described with respect to FIGS. 3 and 4, the total deflection achievable by the fluid menisci is limited by the difference in refractive index between adjacent fluids, and the range of fluid contacts angles feasible due to the intrinsic nature of the fluids. This embodiment enables a greater total deflection angle to be achieved, than could otherwise be realized. Similar features are shown by using similar reference numerals, but with the reference numerals incremented by 100 compared to FIGS. 4 and 200 compared to FIG. 3 (i.e. end surface 104, 204 from FIGS. 3 and 4 is now labeled 304). In this embodiment, the pair of sidewall electrodes 341, 343 does not lie parallel to each other. The same applies to the perpendicular pair of sidewall electrodes 342, 344 (not shown). In this embodiment, the side wall electrodes are arranged as a frustrum. By applying appropriate voltages V₁₂ and V₁₃ across the end electrode 312 and respective side electrodes 341, 343, when the resulting fluid contact angles θ₁₂ and θ₁₃ are of appropriate values, a flat fluid meniscus 94 is obtained between liquid A and B. It will be appreciated, that as the side walls do not lie parallel to each other, then such a flat fluid meniscus 94 will not be obtained when the sum of the fluid contact angles θ₁₂ and θ₁₃ equals 180°. An incoming light beam along optical axis 301 would then be deflected one dimensionally by the meniscus 94 to a direction with a second optical axis 96. The first and second optical axes are related to each other by the deflection angle θ₉₆.

In the embodiments described with reference to FIGS. 3-6B it is assumed that the beam deflector element is provided using the electrowetting effect. However, it will be appreciated that other mechanisms can be utilized to provide a variable beam deflection. Such mechanisms can be mechanical e.g. by direct movement of a deflecting element (e.g. a mirror or diffraction grating). As mechanical actuators are prone to fatigue, preferably the beam-deflecting element acts by control of the configuration (e.g. shape or orientation) of a fluid or fluid interface.

For instance, a cell containing a material having a variable refractive index could be provided. A suitable material is a liquid crystal in the nematic phase. By appropriate application of voltage, it is possible to alter the orientation of the liquid crystal, and hence control the refractive index of the cell along a predetermined direction. The angle of refraction experienced by a beam passing from one material to another material depends upon the difference in refractive index of the two materials. Accordingly, a beam deflector element can be formed by providing a layer of liquid crystal, with at least one surface of the layer extending transverse (i.e. across) the optical axis 19b of the detector system 10. This surface will typically be planar. The angle between the planar surface and the optical axis 19b is non-orthogonal i.e. the plane of the surface does not extend perpendicular to the optical axis 19b. Thus, by appropriate application of control voltages to the layer of liquid crystal, the orientation of the liquid crystal can be altered. Thus, the refractive index of the layer experienced by light incident on the layer along optical axis 19b can be varied. This allows a variation in the angle of deflection experienced by the beam refracting upon the transition between the liquid crystal and the adjacent medium. Typically, the adjacent medium will be an isotropic material, such as air or PMMA (polymethylmethacrylate). The angle under which the radiation beam is deflected, will depend upon the three-dimensional position of the refracting surface separating the liquid crystal material from the isotropic material, and on the refractive index of the isotropic material and the refractive index of the liquid crystal material experienced by the polarized radiation beam. The directors of the liquid crystal may be arranged to be aligned under a predetermined direction, e.g. by use of alignment materials such as polyimides.

The refractive index experienced by the beam of light passing through a liquid crystal is dependent upon the relative orientation of the liquid crystal compared to the polarization of the light beam.

If the radiation beam should be non-polarized, then an alternative beam deflecting element can be provided. Such a beam deflecting element simply combines two sections. Each section is formed by providing a layer of liquid crystal and a layer of isotropic material, with an interface or surface extending non-orthogonal to the optical axis 19b. Typically, these non-orthogonal surfaces from each section will be parallel. The two sections differ, in that the liquid crystal within each section is orientated at a different angle. For instance, directors of the liquid crystal in the first layer can be orthogonal to the directors of the liquid crystal in the second layer e.g. if the directors of the first layer liquid crystal extend in the X-direction, then the directors of the second liquid crystal layer will extend in the Y-direction. The first section will thus act to alter the deflection of the radiation beam having a first polarization, whilst the second layer will act to alter the direction of the portion of the radiation beam having a second polarization. The resultant effect will be that the non-polarized beam (i.e. the beam incorporating all polarizations) will be deflected by the deflecting element including the two sections. Such a beam deflector is described within unpublished Philips patent application entitled “Polarization-Independent Liquid Crystal Beam Deflector”, filed on 22 Jun. 2004, Philips reference PHNL 040.742 EPP.

In the above embodiments, the beam-deflecting element has no optical power i.e. it is not arranged to converge (or diverge) the radiation beam, but simply to alter the path of the beam. In other embodiments, the beam deflective element may have an optical power. Preferably, such an optical power is suitable for use in facilitating the focusing of the reflected beam on to the detector surface. FIGS. 7A and 9 show examples of variable fluid meniscus apparatus having an optical power. These embodiments are suitable for use in the apparatus shown in FIG. 8.

In the optical scanning device shown in FIG. 8, the detector system does not contain a separate lens 25. Rather, focusing of the reflected beam 22 is achieved by the beam-deflecting element 830. Further, in this particular embodiment, it can be seen that the axis of the radiation beam output from the radiation source 7 is perpendicular to the optical axis of the objective lens system 8. In other words, beam splitter 9 acts to reflect the radiation from radiation source 7 towards the optical disc 3, via collimator lens 18. Consequently, in this embodiment, the reflected radiation from the optical record carrier 3 is transmitted by the beam splitter 9 towards the detector 23. Otherwise the device is generally similar to that illustrated in FIG. 1.

FIG. 7A shows a tunable micro lens, as described in more detail in U.S. Pat. No. 6,538,823. Such a tunable micro lens 630 is suitable for use as a beam-deflecting element in an optical scanning device, in accordance with an embodiment of the present invention. The micro lens includes a droplet of a transparent conducting liquid 602 disposed on a first surface of an insulating layer 604. A plurality of electrodes 606a-606d are disposed on the surface of the insulating layer 604 distant from the droplet 602. The plurality of electrodes 604a-604d are disposed such that each may be selectively biased to a respective voltage potential between the droplet and each of the plurality of electrodes, such that the contact angle θ between the droplet edge and each of the adjacent electrodes is variable. The voltages are all applied with respect to electrode 108, which is in electrical contact with the fluid 602. The fluid 602 is a conducting, polar fluid. FIG. 7B shows a plan view of the electrodes 606a-606d. Voltage V₆₁ is applied between electrode 606a and electrode 108, V₆₂ between electrode 606b and electrode 108, V₆₃ between electrode 606c and electrode 108, and V₆₄ between electrode 606d and electrode 108.

If equal voltages are applied to all four electrodes, then the droplet 102 spreads equally across the four quadrants I-IV of the beam-deflecting element 630. By changing the values of such equal voltages, the contact angle θ can be adjusted. By selectively biasing the electrodes 606a-606d unequally, then the position of the drop can be altered. For example, if V₆₁ and V₆₃ are set at approximately equal voltages, and V₆₂ is greater than voltage V₆₄, then the droplet will move towards quadrant II, and the lateral position of the focal spot of the beam-reflecting element 630 in the focal plane is thereby adjusted. By altering the contact angle θ by control of the magnitude of each of the voltages, then the shape of the droplet 602 will be adjusted, and hence the focal length of the droplet.

Thus, the element 630 provides a beam-deflecting element, which has both lateral control of the position of a spot on the detector 23, along with a tunable focal point.

The disadvantage of the embodiment shown in FIG. 7A is that the function of the element may be affected by the orientation of the element relative to gravity.

To eliminate the influence of gravitational force, the beam-deflecting element 930 shown in FIG. 9 can be utilized. A more detailed description of the general functioning of such a device can be found in U.S. Pat. No. 6,369,954. The influence due to gravity is overcome by using two fluids 911, 913 contained within a chamber, with the fluids being of substantially equally density. Again, the device uses the electrowetting effect, with the contact angle of the meniscus between the two fluids being tunable by variation of the electrowetting force. The fluid 913 is the conductive polar fluid. The droplet of fluid 911 is non-polar.

Electrode 917 is in electrical contact with the conductive fluid 913. The two fluids have different refractive indices. The second fluid 911 is located on a surface 912 of the chamber. The chamber wall 912 on which the second fluid 911 sits is a dielectric. The dielectric has a low wetting with respect to the conductive liquid 913. Further, a hydrophilic surface 914 is applied around the periphery of the desired position 915 of the second fluid 911 to further maintain the positioning of the drop of the second fluid 911. Electrodes 916 are arranged on the distant side of the dielectric 912. These electrodes are shaped, and positioned, in the same manner as the electrodes shown in FIG. 7B. By application of appropriate voltages between the electrode 917 and each one of electrodes 916, the focal power provided by the beam deflecting element 930 can be altered e.g. the shape of the drop of second fluid 911 can be altered between that shown by solid line 9A, and that shown by dotted line 9B. Equally, the position of the drop can be altered by applying different voltages to each of the electrodes 916, in the same manner as described with reference to the embodiments shown in FIGS. 7A and 7B.

Alternatively, the influence of gravitational force can be eliminated from the embodiment shown in FIG. 7A by ensuring that the fluid 602 that is electrically susceptible is located within a chamber. The remainder of the chamber is filled with a second fluid that is non-polar, with the fluids being of substantially equal density. By providing beam-deflecting elements as described herein, the present invention enables control of the lateral position of the reflected beam incident on the detector 23. Such control can be used to offset errors of alignment of the various optical components within an optical scanning device, and thus improve the ability of the device to resist variations in temperature and/or prolong the lifetime of the device.

1. An optical scanning device (1) comprising:
a radiation source (7) for providing an incident radiation beam (4, 20) along a first optical path (19a) for scanning an information layer (2) of an optical record carrier (3);
a detector (23) for detecting at least a portion of the radiation beam (22) reflected from the optical record carrier (3); and
a beam splitter (9) for transmitting the incident radiation beam (4) received from the radiation source along the first optical path (19a) towards the optical record carrier, and for transmitting said reflected beam (22) received from the optical record carrier (3) along a second, different optical path (19b) towards the detector;
wherein the optical scanning device further comprises a beam deflecting element (30; 130; 230; 330; 630; 830; 930) positioned on the second optical path (19b) between the beam splitter (9) and the detector (23), and arranged to controllably deflect the path of the reflected radiation beam (22) for adjusting the lateral position of said reflected radiation beam incident upon the detector (23) over a predetermined range.

2. An optical scanning device as claimed in claim 1, wherein the beam-deflecting element (30; 130; 230; 330; 630; 830; 930) is arranged to alter the path of said reflected radiation beam (22) by refraction.

3. An optical scanning device as claimed in claim 1, wherein the beam deflecting element (30; 830) comprises a material of variable refractive index, at least one surface of the material extending across, but not perpendicular to, the second optical path.

4. An optical scanning device as claimed in claim 3, wherein the material of variable refractive index comprises a nematic liquid crystal.

5. An optical scanning device as claimed in claim 1, wherein the beam deflecting element (30; 130; 230; 330; 830; 930) comprises:
a chamber containing a first fluid (A; 602; 911) having a first refractive index, a second fluid (B; B′; 913) having a second, different refractive index separated from the first fluid across an interface (80; 86; 88; 94; 9A, 9B), the interface extending across the second optical path (19b); and
an interface controller (112, 141, 143; 212, 241a, 241b, 243a, 243b; 312, 341, 343; 606a, 606b, 606c, 606d; 916, 917) arranged to alter the configuration of the interface.

6. An optical scanning device as claimed claim 5, wherein said interface controller (112, 141, 143; 212, 241a, 241b, 243a, 243b; 312, 341, 343; 606a, 606b, 606c, 606d; 916, 917) is arranged to alter the shape of the interface (80; 86; 88; 94; 9A, 9B).

7. An optical scanning device as claimed in claim 5 wherein said interface controller (112, 141, 143; 212, 241a, 241b, 243a, 243b; 312, 341, 343; 606a, 606b, 606c, 606d; 916, 917) is arranged to alter the angle of the interface (80; 86; 88; 94; 9A, 9B) relative to the optical path (19b).

8. An optical scanning device as claimed in claim 5, wherein one of said fluids is electrically susceptible, and the interface controller (112, 141, 143; 212, 241a, 241b, 243a, 243b; 312, 341, 343; 606a, 606b, 606c, 606d; 916, 917) is arranged to alter the configuration of the interface utilizing the electrowetting effect.

9. An optical scanning device as claimed in claim 5, wherein said interface (80; 86; 88; 94) is substantially planar.

10. An optical scanning device as claimed in claim 5, wherein said interface (9A, 9B) is curved for focusing said reflected beam on the detector (23).

11. An optical scanning device as claimed in claim 1, further comprising a beam deflection controller arranged to alter the deflection provided by the beam deflecting element (30; 130; 230; 330; 630; 830; 930) in dependence upon the signal detected by said detector.

12. An optical scanning device as claimed in claim 1, wherein a focus error signal is formed by the astigmatic method, with the radiation beam (22) reflected from the optical carrier (3) forming only a single spot on the detector (23).

13. An optical scanning device as claimed in claim 1, wherein the detector (23) comprises at least two detector elements (S1, S2, S3, S4).

14. An optical scanning device as claimed in claim 1 wherein the detector (23) is a quadrant detector,
said beam deflecting element is arranged to controllably deflect the path of the reflected radiation beam (22) for adjusting the lateral position in a first direction of said reflected radiation beam incident upon the detector (23); and
wherein the device further comprises a further beam deflecting element positioned on the second optical path (19b) between the beam splitter (9) and the detector (23), and arranged to controllably deflect the path of the reflected radiation beam (22) for adjusting the lateral position of said reflected radiation beam incident upon the detector in a second direction substantially perpendicular to the first direction.

15. A method of operating an optical scanning device (1), the device comprising: a radiation source (7) for providing an incident radiation beam (4, 20) along a first optical path (19a) for scanning an information layer (2) of an optical record carrier (3); a detector (23) for detecting at least a portion of the radiation beam (22) reflected from the optical record carrier (3); a beam splitter (9) for transmitting the incident radiation beam (4) received from the radiation source along the first optical path (19a) towards the optical record carrier (3), and for transmitting said reflected beam (22) received from the optical record carrier (3) along a second, different optical path (19b) towards the detector (23); and a beam deflecting element (30; 130; 230; 330; 630; 830; 930) positioned on the second optical path (19b) between the beam splitter (9) and the detector (23), and arranged to controllably deflect the path of the reflected radiation beam (22) for adjusting the lateral position of said reflected radiation beam incident upon the detector (23) over a predetermined range,
the method comprising controlling the deflection provided by said beam deflecting element (30; 130; 230; 330; 630; 830; 930) to the path of the reflected radiation beam (22), for providing the reflected radiation beam incident upon the detector (23) at a predetermined lateral position.

16. A method of manufacturing an optical scanning device (1), comprising:
providing a radiation source (7) for providing an incident radiation beam (4, 20) along a first optical path (19a) for scanning an information layer (2) of an optical record carrier (3);
providing a detector (23) for detecting at least a portion of the radiation beam (22) reflected from the optical record carrier (3); and
providing a beam splitter (9) for transmitting the incident radiation beam (4) received from the radiation source along the first optical path (19a) towards the optical record carrier, and for transmitting said reflected beam (22) received from the optical record carrier (3) along a second, different optical path (19b) towards the detector; and
providing a beam deflecting element (30; 130; 230; 330; 630; 830; 930) positioned on the second optical path (19b) between the beam splitter (9) and the detector (23), arranged to controllably deflect the path of the reflected radiation beam (22) for adjusting the lateral position of said reflected radiation beam incident upon the detector (23) over a predetermined range.
